(19) United States
(12) Patent Application Publication
(10) Pub. No.: US 2002/0127528 A1
(43) Pub. Date: Sep. 12, 2002

(54) Incentive based training system and method

(75) Inventor: Douglas D. Potter, Plano, TX (US)

Correspondence Address: OSTROLENK FABER GERB & SOFFEN, 1180 AVENUE OF THE AMERICAS, NEW YORK, NY, 100368403

(73) Assignee: Spar Inc.

(21) Appl. No.: 09/951,321

(22) Filed: Sep. 13, 2001

Related U.S. Application Data
(60) Provisional application No. 60/240,328, filed on Oct. 13, 2000.

(51) Int. Cl. G09B 7/00

(52) U.S. Cl. 434/322

(57) ABSTRACT

Disclosed is a method and a system for carrying out via a communications network the method for training of personnel at an organization including providing training materials for the independent study of the personnel being trained, providing one or more tests on the provided training materials, awarding reward points for passing the tests, and allowing the training personnel to redeem gifts based on the points awarded. The reward points for passing the tests may be combined with other reward points such as points earned because of work related performance, such as points earned for sales performance.

### RELATED APPLICATIONS

This application is based on and claims the benefit of U.S. Provisional Application Serial No. 60/240,328, filed Oct. 13, 2000 and entitled “INCENTIVE BASED TRAINING SYSTEM AND METHOD, the entire disclosure of which is incorporated by reference herein.

### BACKGROUND OF THE INVENTION

The present invention relates to a method of training, and in particular to a system for executing a training method and more preferably a method for training of salespersons on a communication network.

In today's competitive business environment, effective response to demands of customers for service is a key factor in the successful merchandising of products. One form of service that is particularly demanded, especially in technical fields, is the availability of competent technical advice from the product manufacturers or their sales agents. Such customer demands are particularly great in markets where the products change rapidly and customers require technical information in making a decision to purchase a product. An example is the computer industry in which not only there is a great number of existing products, but there is a new product reaching the market every day. In this industry, these two factors often complicate a customer's decision making in purchasing the proper equipment for a particular application. Therefore, customers often turn to the salespersons for technical advice as to, for example, propriety of an application of a given equipment or as to selection of an equipment from among a number of possible choices. In short, the nature of such businesses places a burden on the industry to educate their customers as to the suitability of a product for their needs, and thus involves providing technical advice to the customers as not only a service to the customer, but a requirement in merchandising products and thus a necessity in remaining competitive.

Naturally, to provide such technical advice, the salespersons must be informed of the relevant technical aspects of the products. Where there are on-going changes to a product line, it is highly desirable to maintain an on-going training program whereby the salespersons may be kept informed of the new products. Moreover, it is highly desirable to have a training program that can also be used to train new sales agents in the existing products, as well as the new products. Of course, in both cases, it is desirable to have a responsive training program that educates the salespersons about the new products as efficiently, and as cost-effectively as possible.

In order to achieve the foregoing, a training format may be devised for the training of the salespersons. There are many conventional training formats. A format typically used is one-to-one training which requires one person to teach a person or a group of persons. There are drawbacks to such a format.

For example, training can only be conducted in a given session, at a given time, and in a given location. Hence, those who cannot or do not attend will not be able to benefit from such training. Moreover, this format cannot, for example, provide a solution to the problem of training new salespersons joining after such a training session has been conducted. To overcome these drawbacks, training sessions must be repeatedly conducted on an ongoing basis. Such on-going programs may be very costly, and time consuming specially for a product manufacturer whose salespersons are dispersed across a wide geographical area, such as the United States, or perhaps across the world. In addition, on-going programs cannot address attendance problems, which are often caused by the inconvenience of the time or place of the training sessions. Also, because arrangement of such training sessions requires time for preparation, scheduling, etc., such a format does not optimally keep the salespersons informed of the rapid changes in the line of products.

Another typical training format involves providing training literature to the salespersons and relying on the salespersons to self-train. Although training under such a format overcomes some of the drawbacks of the previous example, it includes some of its own. For example, it is difficult to determine whether all of the salespersons are studying the training literature, or whether they are learning well from the literature.

Another drawback in such a format is that when it is desirable to train a salesperson about a number of products, it is difficult to determine whether the salesperson is learning all of the products well, or only some of the products. Hence, using this format, one cannot effectively monitor the level of knowledge of a given salesperson about each and every product, thereby making it difficult to isolate a product or group of products for which further training may be required for that agent. Naturally, this means that the collective level of knowledge of the sales staff at an organization cannot be determined objectively either. This format, therefore, fails to effectively provide objective information that may be of value for management of an organization.

It is, therefore, highly desirable to devise a format for the training of the sales personnel in an organization that overcomes all of the drawbacks of the foregoing training formats. It is also desired that such system be cost effective, accessible to all salespersons conveniently, capable of encouraging salespersons to self-train, capable of providing up-to-date training materials about new products to all salespersons, capable of maintaining accessible information about existing products for new salespersons, and capable of tracking the level of knowledge of each of the salespersons about the products for the purpose of collecting objective information for use in strategic business decision making. Additionally, it is highly desirable that such a system have the capability, preferably in real-time, to change training materials based on a participant's ability to learn and/or to add new features to the training material.

The benefits of training programs for an organization are not just realized in sales. Effective training may be of value in other aspects of a business. On-going training programs may be used to enhance the employees' knowledge in order to further the effectiveness of the employees. For example, employees engaged in production may be trained on quality control matters in an on-going basis to increase the quality of the end products. The invention that is the subject of this application provides a solution in the way of a method, and a system for implementing the method, for the training of personnel at an organization that is applicable to sales and other parts of a business.

### SUMMARY OF THE INVENTION

A first object of this invention is to provide a training method that encourages employees of an organization to self-train.

Another object of this invention is to provide an incentive based system to carry out an incentive based method for the training of employees at an organization.

Yet another object of this invention is to provide a method for objectively tracking the training progress of employees at an organization.

An additional objective of this invention is to provide a method for monitoring the effectiveness of an incentive based training program at more than one organization. Another objective of this invention is to implement the disclosed method in using a publicly accessible communication network, such as the Internet, to overcome the drawbacks associated with the conventional methods of training, a few of which have been described.

These and other objects are achieved in accordance with certain features of the invention by a method for administering an incentive based training program for a number of trainees via a communication network, the method comprising: administering a test having a number of questions to one of the trainees via the communications network; awarding test reward points to the participant when a pre-determined percentage of questions has been answered correctly; and providing a redemption listing to the participant via the communications network, the redemption listing including at least one redeemable item having corresponding redemption points, whereby the participant can select the at least one redeemable item by submitting a request for its redemption via said communications network.

As an alternative to submitting a request for redemption via the communications network, the trainee may automatically receive an award when achieving a predetermined number of reward points. As a further alternative, a trainee after being awarded a reward item may have the option of trading-in the awarded item for a comparable item.

### BRIEF DESCRIPTION OF THE DRAWINGS

For the purpose of illustrating the invention, the drawing demonstrate a preferred form; it being understood however, that the invention is not limited to the precise arrangements and instrumentalities shown.

FIG. 1 is a diagram showing a conventional arrangement of computers connected to a global communication network such as the Internet, which may be used in implementing the invention.

FIG. 2 is a flow chart showing steps for implementing certain aspects of an exemplary embodiment of the invention.

FIG. 3 shows an example of a form used to collect information from a user using the system shown in FIG. 1.

FIG. 4 shows an example of a home page of a participating organization in the system.

FIG. 5 shows an example of an information communication screen containing training material that may be displayed to a user of the system according an embodiment of the invention.

FIG. 6 shows an example of an information communication screen containing a question from a test that may be administered to a user of the system according to an embodiment of the invention.

FIG. 7 shows another example of an information communication screen containing a question from a test that may be administered to a user of the system according to an embodiment of the invention.

FIG. 8 shows an example of an information communication screen displayed to a user in which the results of a test may be displayed to a user according to an embodiment of the invention.

FIG. 9 shows an example of an information communication screen containing a table which includes data reported from a database according to an embodiment of the invention.

FIG. 10 shows an example of an information communication screen displaying data regarding the time, the date and the percentage of correct answers for a test received by the system from a user according to an embodiment of the invention.

FIG. 11 shows an example of an information communication screen containing data regarding the number of test reward points earned by a user according to an embodiment of the invention.

FIG. 12 is a flow chart showing steps for implementing award redemption in accordance with certain aspects of an exemplary embodiment of the invention.

FIG. 13 shows an example of an information communication screen containing a list of category of items that may be redeemed by a user in exchange for reward points obtained by passing the test that are administered to the user according to an embodiment of the invention.

FIG. 14 shows and example of an information communication screen containing a list of selectable items in a category selected from the list shown in FIG. 9 according to an embodiment of the invention.

FIG. 15 shows an example of an information communication screen containing a report generated using the data from the database according to an embodiment of the invention.

### DETAILED DESCRIPTION OF THE INVENTION

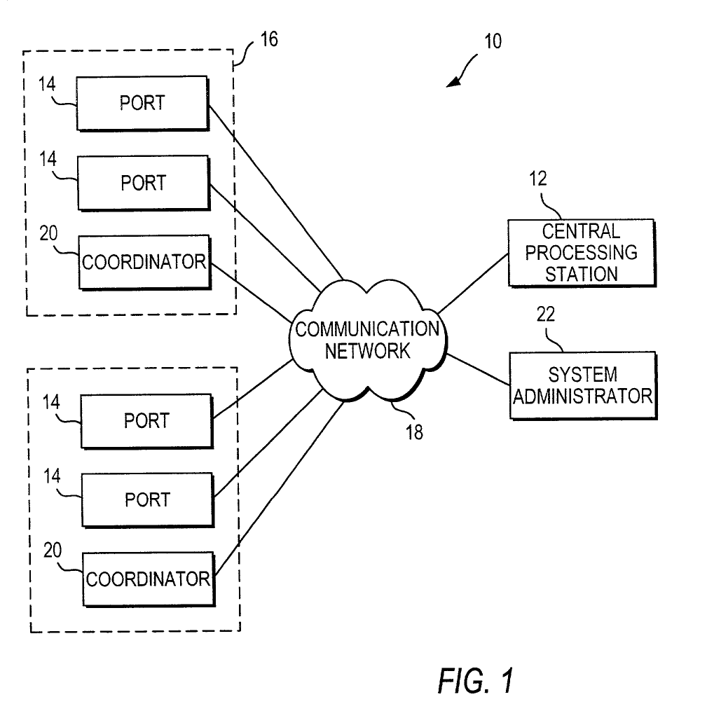

Referring now to the drawings wherein like numerals indicate like elements, there is shown in FIG. 1 an incentive based training system constructed in accordance with the principles of the present invention and designated generally as 10. The heart of incentive based training system 10 is a central processing station 12 which communicates with various participants 14 via a communication network 18, preferably a world wide communication network such as the Internet.

The central processing station 12 administers tests to the participants 14, keeps track of their scores on the tests, maintains a database of the points awarded to each participant 14, allows the participants 14 to redeem earned points and carries out various other administrative functions described below. The various physical components (e.g., processors, monitors, storage facilities, etc.) of the central processing station 12 may be located at a single central location or may be distributed over various locations and in communication with one another over any private or public communication network. The processing station 12 is “central” in the sense that it administers the main functions of the incentive based training system 10, not in the sense of a geographic location.

Each participant 14 is part of a respective organization 16 which has registered with the central processing station 12 for the purpose of having their employees (or other individuals whom they would like to train) participate in the incentive based training system. The participants 14 communicate with the central processing station 12 via any suitable communication network 18, preferably a world wide communication network such as the Internet. Each participant 14 is an individual who uses a suitable communication device, such as a PC, an interactive VRU or a telephone. More than one participate 14 can use the same communication device to communicate with the central processing system 12, as long as they identify themselves when signing into the system.

Each organization 16 will assign one or more coordinators 20 who are also in communication with the central processing station 12 and who provide coordinating information (e.g., the identity of the participants associated with the organization which the coordinator 20 represents) to and receives various administrative information (e.g., information on which participants passed which tests) from the central processing station 12. The details of this information are described below.

A system administrator 22 is connected to the central processing system 12 and administers various functions of the system, as well as communications with the coordinators 20. While the system administrator 22 is shown as being a single individual communicating with the central processing station 12 and the coordinators 20, more than one person can perform the functions of the system administrator described below. The system administrator 22 is also shown as being in communication with the central processing station 12 and the coordinators 20 via the communication network 18. However, the system administrator 22 can be in communication with the central processing station 12 and the system administrators 22 in any desirable manner.

In the preferred embodiment, the communication network is the Internet and the participants 14 communicate with the central processing system using standard web page technology. However, the invention is not limited to this type of communication. Indeed, portions of the system can be carried manually such as by having a participant communicate with a live person over telephone lines who then administers one or more of the various functions described below.

When an organization 16 wants to train its employees (or other parties) using the incentive based training system 10, it must initially register with the system administrator 22. Typically this is done by the coordinator 20 for the organization 16.

The coordinator 20 will provide the administrator 22 with both training material which the organization 16 would like to be presented to its employees (or other designated individuals) and a list of participants 14 who are entitled to participate in the training program on behalf of the organization 16. The organization 16 will sometimes create the training material on its own (or have it created by a third party) and will sometimes ask the administrator 22 to assist in the creation of this material. The training material will typically include written and/or pictorial material providing information which the organization 16 wants the participants 14 to learn. For example, if the organization 16 provides scanner data to retailers to enable the retailers to determine what goods are being sold, where it is being sold and to whom it is being sold, the organization 16 will want to train its sales people on the benefits of their system and how the system is used. The organization will provide training material to the administrator 22. The system administrator 22 will set up a data base containing this information which is stored at the central processing station and can be called up by any participant 14 authorized by the organization. Each organization 16 can provide one or more sets of such training materials for storage and subsequent access at the central processing station.

Along with each set of training materials, the organization 16 (with the assistance of the system administrator, if requested) will provide a series of questions relating to the training materials. These questions will be used by the system 10 to determine whether or not the participants 14 have mastered the training material. They will also be the basis of providing award points to the participants 14 who can use those points to obtain free prizes. These questions are also stored in a suitable data base at the central processing station and can be accessed by the participants 14 when they want to earn award points.

Once the organization has registered with the system administrator 22 and has provided both the training materials and related questions, its associated participants 14 are free to begin training and earn award points.

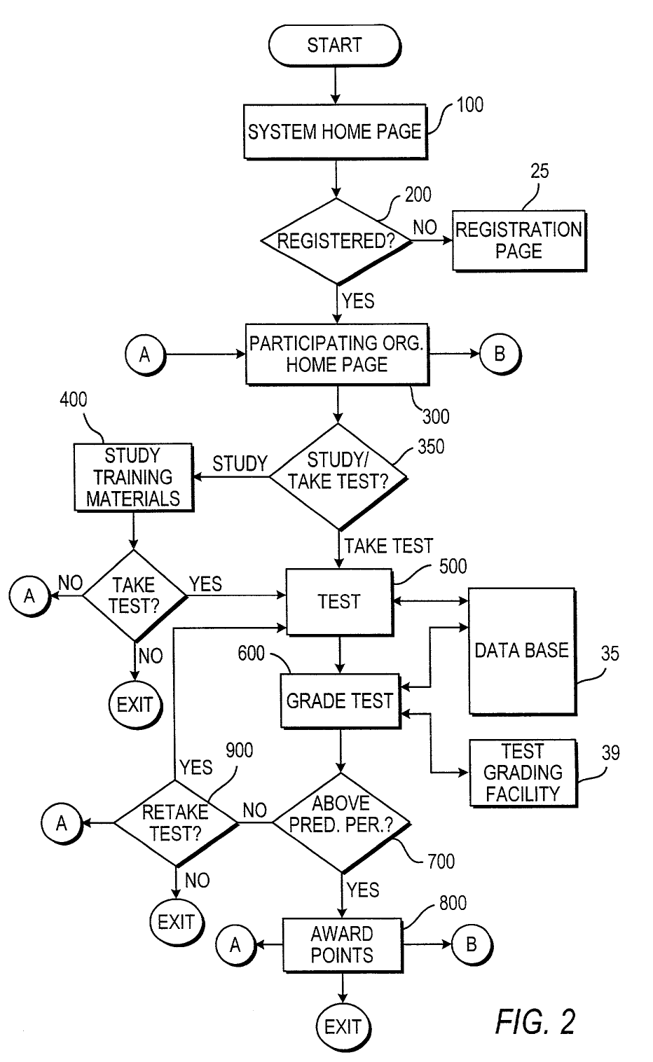

In the preferred embodiment, a participant 14 enters the incentive based training system 10 by visiting a home page web site maintained by the system 10 (step 100, FIG. 2). If it is his or her first visit to the web site, he or she must register and obtain a unique user identification name and a password (step 200, FIG. 2). Thereafter, the registered participant 14 may access the system by providing his or her user identification name and password.

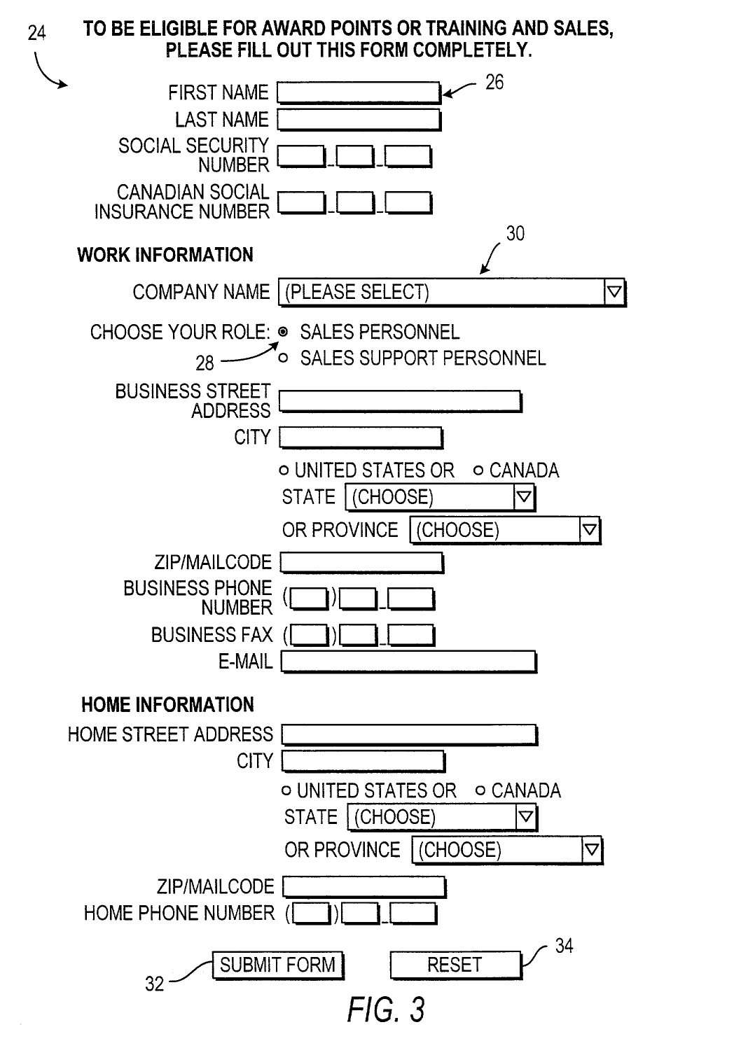

FIG. 3 illustrates an example of a web page 25 which presents a registration form 24 which allows a participant 14 to register with the training system 10.

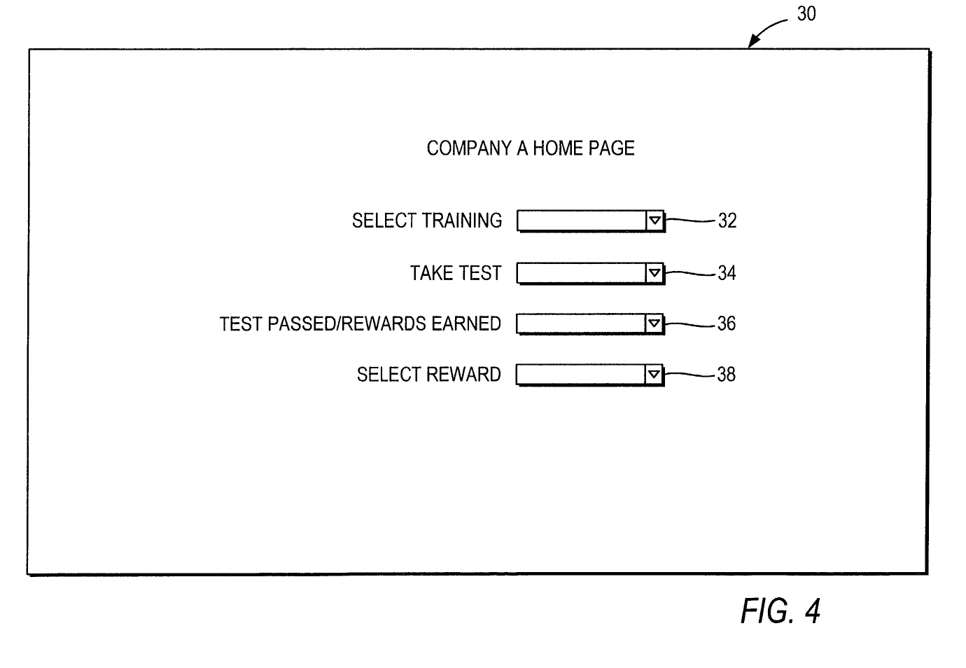

Registration form 24 asks for various information which will identify the participant 14 and the organization 16 with which he or she is associated. Any relevant and/or useful information can be requested. In the preferred embodiment, the information is requested using empty fields 26 (only one of which is labeled in the figure) which must be completed by typing in the relevant information, radio buttons 28 (only one of which is labeled in the figure) which permit the participant 14 to enter information by merely selecting one of a plurality of choices presented to the participant 14 and one or more pull down menus 30 (only one of which is labeled in the figure) which permit the participant to choose from a preselected list of choices. Pull down menus 30 are preferably used for those instances wherein the permitted choices are limited. For example, a pull down menu is used to request the name of the organization (“Company Name” in FIG. 4) with which the participant 14 is associated. Once the registration form 24 is completed, the participant 14 can either submit the form by clicking on the submit form button 32 or can clear the form by clicking on the reset button 34.

Once the registration form 24 is submitted, the information in the form is authenticated by the central processing station 12. If the central processing station 12 concludes that the person completing the form has not been authorized to participate in the training system by the organization identified in the registration form, the central processing station 10 (or alternatively, the system administrator 22) will notify the coordinator 20 of the organization in question that an unauthorized individual is attempting to register with system 10. The system 10 (or administrator 22) will also provide the coordinator 20 with information (e.g., name, social security number, etc.) concerning that individual.

The system 10 can be designed to prevent access to the system by an unauthorized individual. However, it is preferred that the individual be permitted access to the system since the information accessible to him or her is not confidential and since the coordinator 20 of the organization 16 has been informed of the individual's registration with the system. This is advantageous because individuals will sometimes be asked to train themselves on the training system 10 before the coordinator 20 reports that fact to the system administrator 22. There is little downside to permitting at least temporary access to that individual both because the information available to him or her is not confidential and because the coordinator 20 has the option of informing the system administrator 22 to subsequently prevent the individual in question from accessing the system if the person is truly unauthorized.

In the preferred embodiment, the person registering with the system 10 will initially be provided with both a registration name (e.g., the participant's social security number) and a password (preferably randomly generated by the system) whether the participant is on the authorized participant list of not. Thereafter, the participant 14 can access the system 10 using his or her identification name and the pass word unless access is removed because the coordinator 20 for the relevant organization 16 has instructed the system administrator 22 to prevent further access by that participant.

Once the registration process is completed the information on the registration form 24 is preferably stored in a relational database 35 for future access by the central processing system 10.

Once the participant 14 has completed the registration process (or if he or she has previously registered, whenever he or she returns to the system), the participant, after logging-in by providing the previously registered log-in name and password, will be provided with a home page corresponding to the organization 16 with which that participant 14 is associated (step 350, FIG. 2). An exemplary home page 30 is shown in FIG. 4.

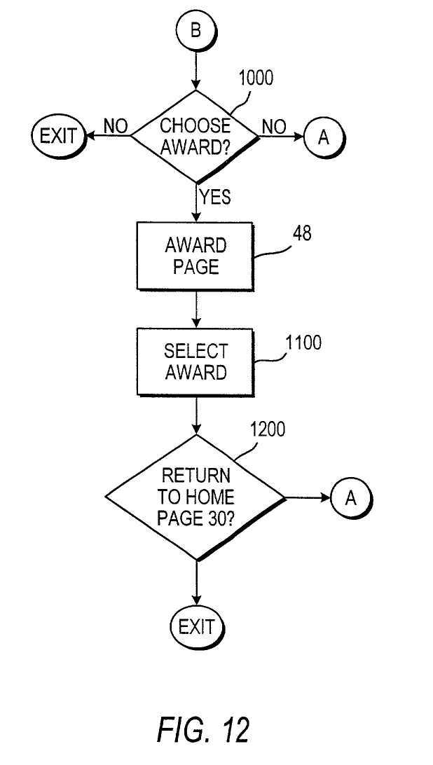

The home page 30 provides links to other web pages which can be accessed by the participant 14. These preferably include one or more content sites 32 which contain training materials, one or more test sites 34 where the participant 14 can take tests he or she is authorized to take, one or more data sites 36 which provide the participant with relevant information such as the number of tests he or she has passed and the number of award points he or she has earned, and one or more sites 38 where the participant can use his or her award points to obtain free merchandise or services (Step B shown in FIG. 12 which will be described later). At step 350 (FIG. 2), the participant by accessing one of the hyperlinks on the home page 30 may either study training materials (step 400, FIG. 3) or take a test (step 500, FIG. 2). Referring to FIG. 2, if the participant decides to study the training materials in step 400, afterwards the participant may the in step 450 take a test (step 500), return to the home page 30 (step A) or end the session.

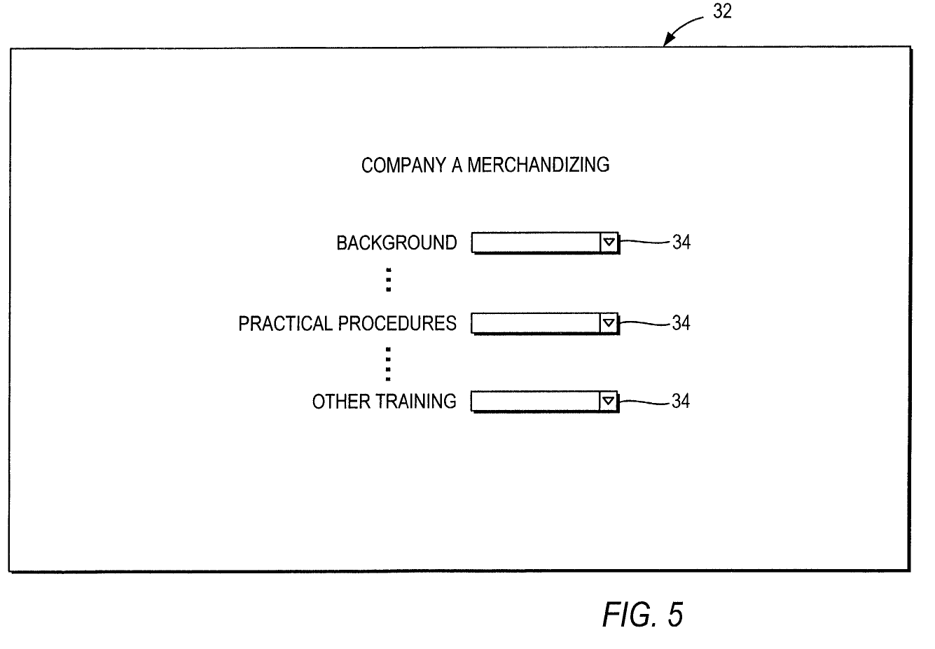

FIG. 5 shows an example of a web page 32 that contains training materials. This page also includes hypertext links 34, which when selected by the participant, link to other web pages containing materials designed for the purpose of training the participant.

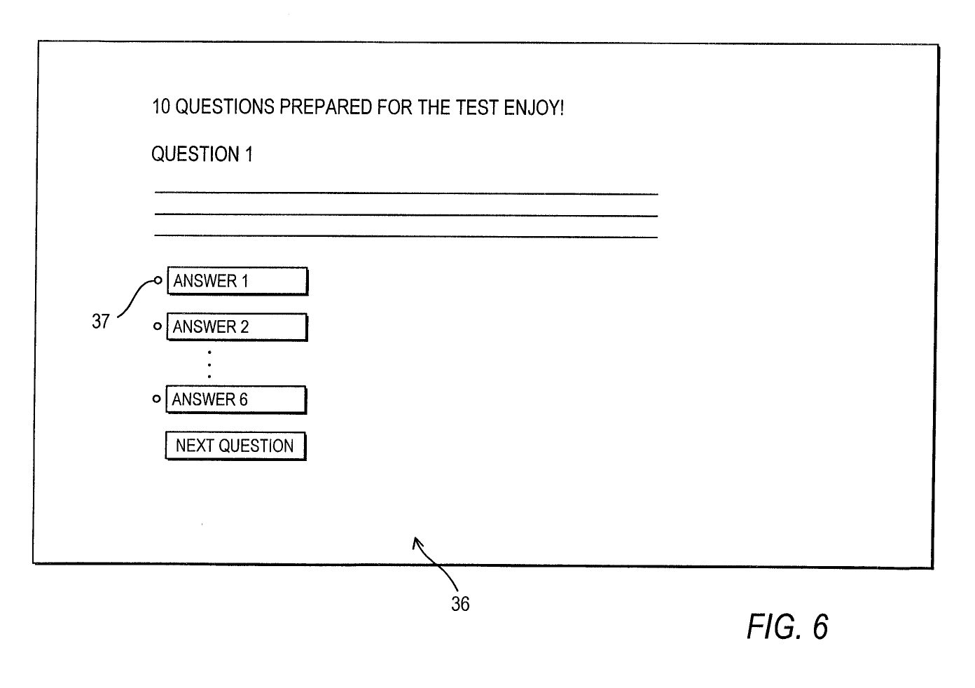

The tests are stored in a test bank in a database 35 (FIG. 2), and may be provided to the participant as requested. Each one of the tests may have a predetermined number of questions, and is preferably provided to the participants as an interactive web page. Each question may be presented in a multiple choice format where a correct answer may be provided with other incorrect answers so that the participant can then make one selection from all of the available choices. FIG. 6 is an example of a web page 36 containing multiple choice questions.

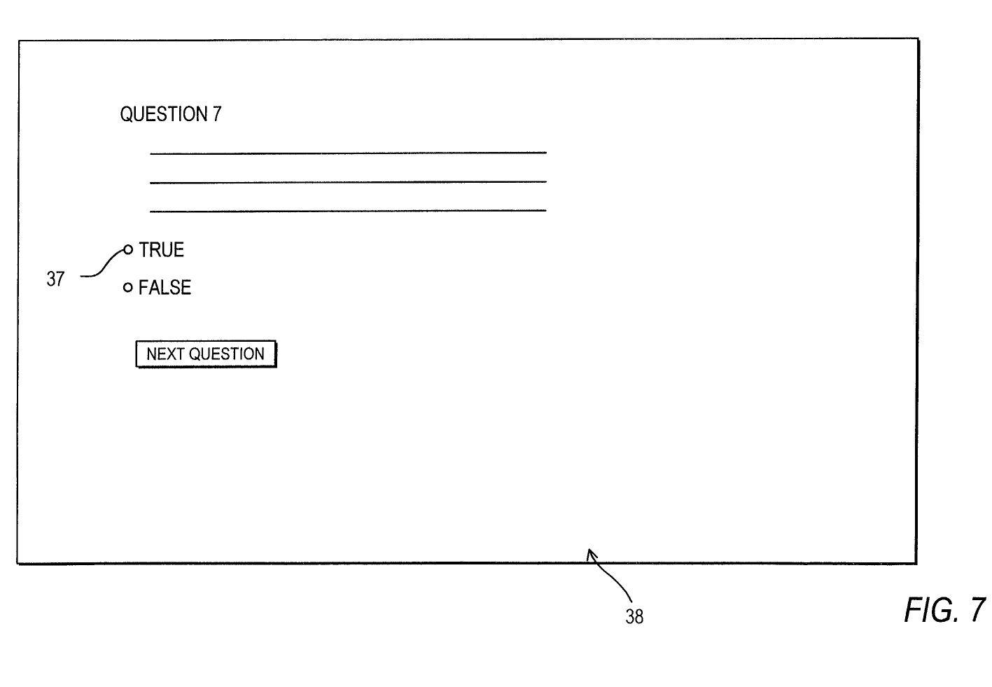

A question may also be presented in a true/false format. FIG. 7 shows a web page 38 having an example of such a question. Whether the question is presented in the multiple choice format of FIG. 6 or the true/false format of FIG. 7, each selectable answer preferably includes a corresponding radio button 37 as shown. By using the radio buttons 37, the selections can be made mutually exclusive, so that only one answer may be submitted to and received by the system.

When all of the selected answers are received by the system, in step 600 (FIG. 2), a test grading facility 39 in the system determines the percentage of correct answers for each given test. In step 700, if the percentage is higher than or equal to a predetermined percentage, the participant is deemed to have passed the test, and is then, in step 800, assigned a predetermined number of reward points. If the percentage is lower than the predetermined percentage, the participant will not pass the test. In the event the participant has not passed a test, the participant may in step 900, retake the test until he or she passes. To avoid a participant retaking the same test, the test questions for a given test are preferably drawn randomly from a larger pool of questions. If the participant decides not to retake the test, the participant may either return to the home page 30 (step A) or redeem a reward (step B of FIG. 12 which will be described later) or exit the system.

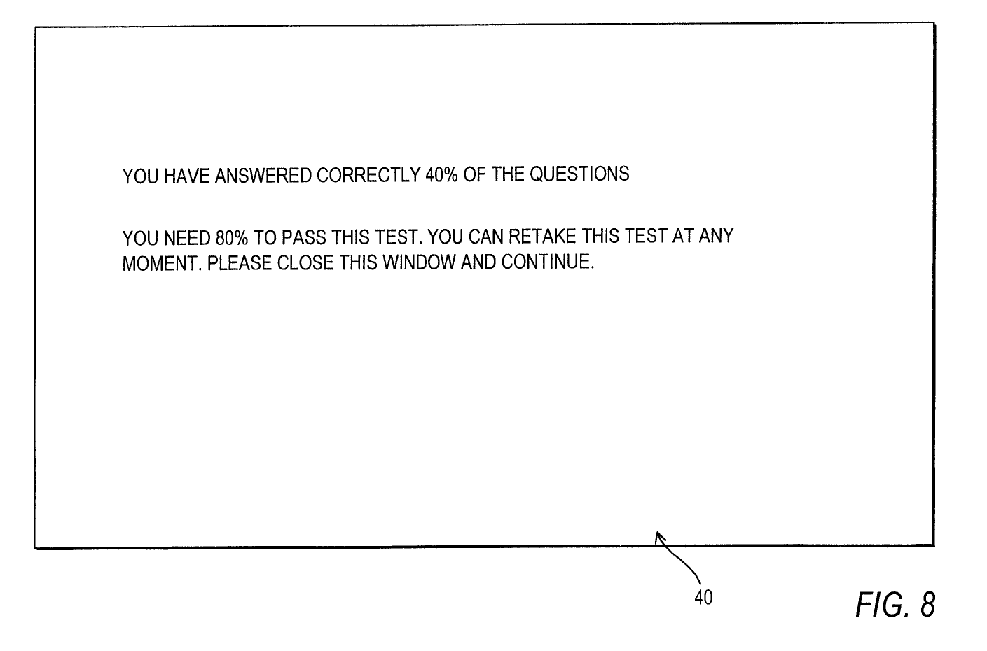

The participant may be preferably notified when he or she has answered a question correctly or incorrectly via web pages (not shown). As shown in FIG. 8, in a web page 40, the participant may also be informed of the percentage of correct answers, and the predetermined percentage of correct answers required for passing the test. In the disclosed embodiment, the predetermined percentage required for passing a test is 80%. This percentage is, however, arbitrary and may be set at any percentage.

The number of times a test is taken by a participant is tracked and sent to the database 35 and stored therein. The database 35 also stores whether the participant has passed a particular test. This information may be retrieved from the database 35 in the form of a table for each participating organization by submitting a query to the database and displayed as a web page.

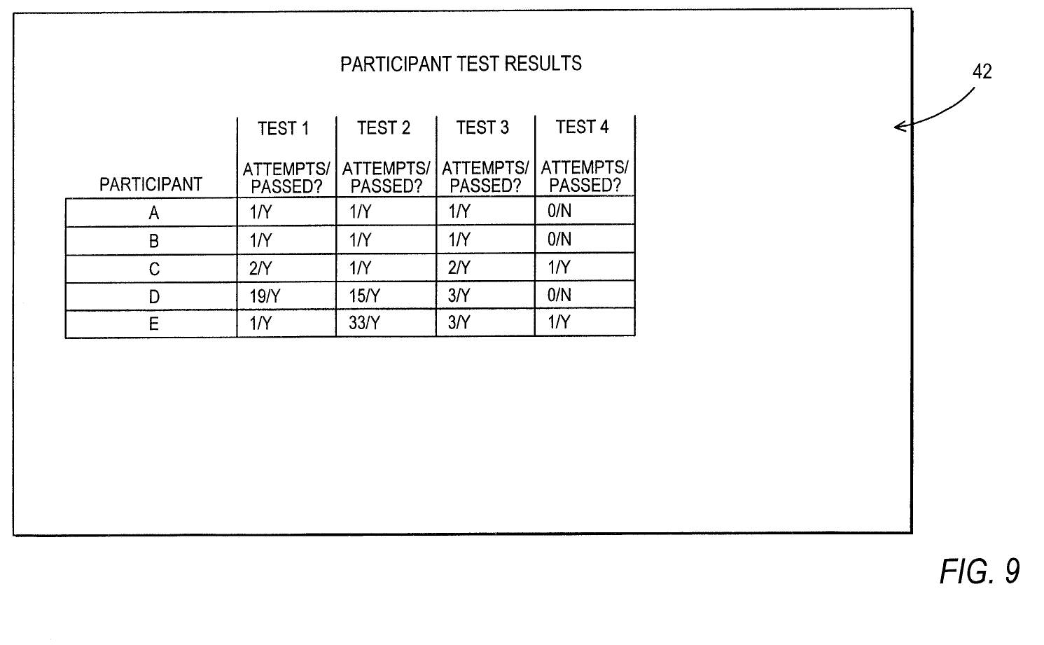

FIG. 9 shows an example of such a table displayed in a web page 42. In this table, a list of participants for a particular participating organization is provided in the leftmost column. In addition, the table also shows whether a participant has passed a particular test, and the number of times the participant has taken that particular test. In this example, the letter “Y” indicates that the participant has passed the test, and the letter “N” indicates that he or she has not. The number to the left of each of these letters indicates the number of times the participant has taken a particular test. The number “0” indicates that the participant has not taken the test.

As shown in FIG. 9, the information is organized such that each row in the table includes results for each test taken by a participant. Thus, the first row includes information about how many times Participant A has taken each of the tests, and whether he or she has passed those tests. More specifically, it shows that this participant has not taken Test 4, but has taken the other tests once, and passed them.

By using this information, one can track the progress of each individual participant in an organization, and determine whether the individual requires training in an area. For example, the table shows that the fifth participant, Participant E, took Test 2 thirty three times before the test was passed. This may indicate that the fifth participant has experienced difficulty with the subject matter of Test 2. Based on this information, a management decision can be made as to whether the fifth participant requires additional training in the subject area tested by Test 2.

In addition, in this table, the results for each one of the tests are organized in a column. These results may provide an objective factual basis for determining which technical areas have presented difficulties for the participants, and which areas have not. Based on such information, management decisions can be made as to whether further training in a particular area is necessary for the participants. For example, with respect to Test 2, it is shown that in one instance this test was taken 15 times, and in another 33 times before it was passed. This may indicate that the technical area that is the subject of Test 2 has presented difficulties for the participants. A decision, therefore, can be made as to whether further training may be required in the technical area relating to the subject matter of Test 2 for all of the participants. Any changes to the training materials may be made in real time, if so desired, by use of an interactive wizard or the like.

The table which is obtained from the results of the test objectifies the training of the participants, and thus may serve as a valuable tool in the decision making process in the management of a business.

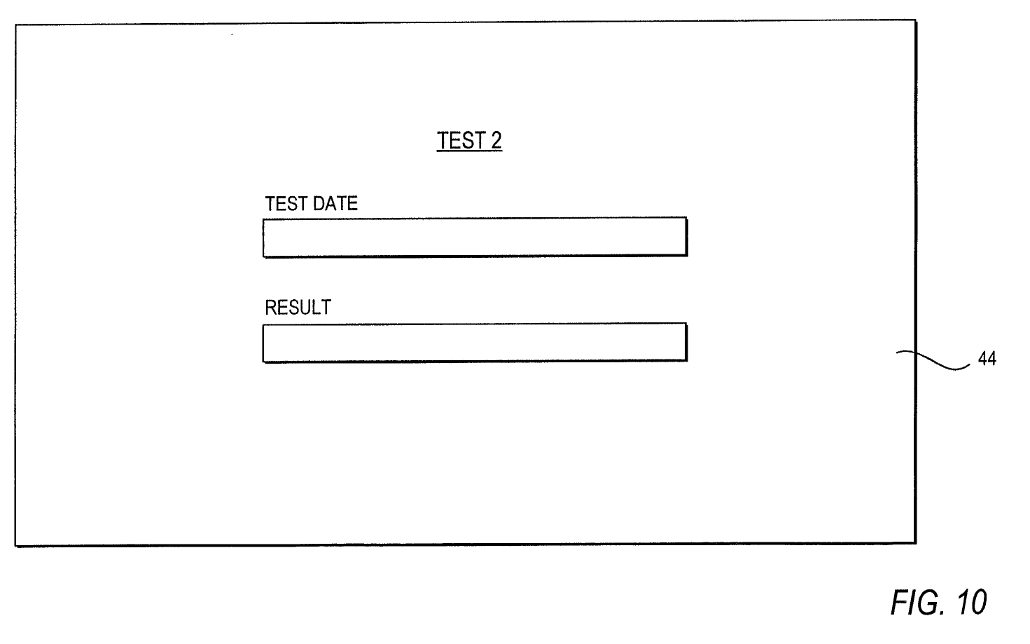

The database 35 may also store the percentage of questions answered correctly each time a test is taken, as well as the time and the date each test is taken. This information may also be retrieved and displayed as a web page 44 as shown in FIG. 10.

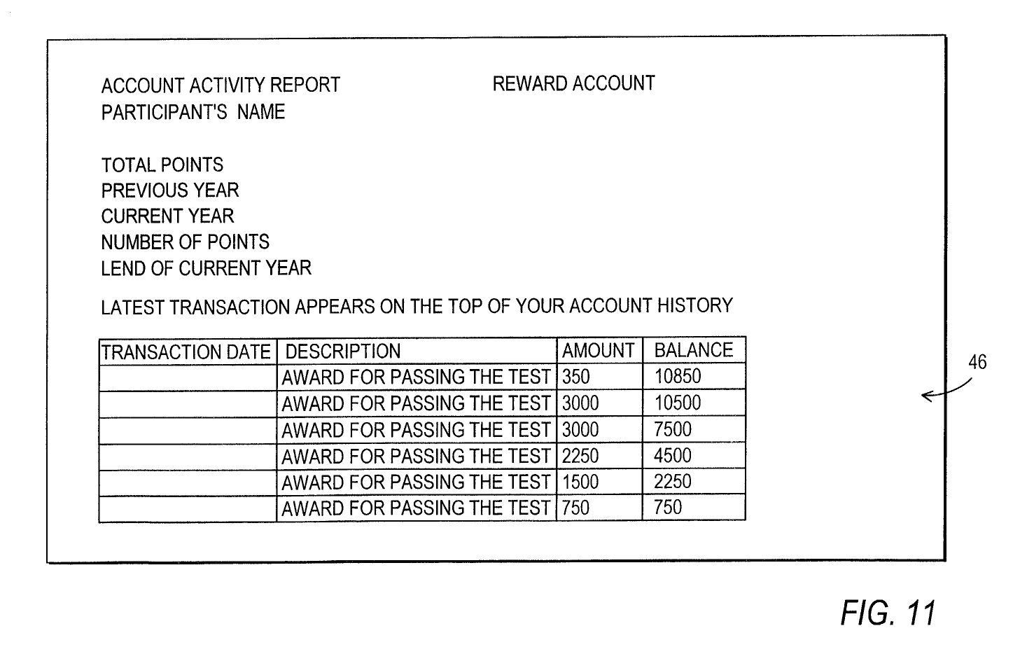

Moreover, a participant's reward points for passing each test may be retrieved and displayed as a web page along with the time and date each test was passed. FIG. 11 shows an example of a web page 46 table displaying this information for a particular participant. In this table, the column labeled Transaction Date includes the date and the time of passing of a test. The column labeled Description describes the transaction, in this case, passing a test. In the column labeled Amount, the number of reward points awarded for passing the test is indicated, and in the column labeled Balance, the total number of reward points is displayed.

Along with the table shown in FIG. 11, other information may also be displayed. For example, in FIG. 11 total points earned in the year, points redeemed (the significance of which will be discussed later), adjustments, the current balance which is equal to the latest balance indicated in the table, and, if points must be redeemed within a certain period, the number of points to expire at the end of the year may be displayed.

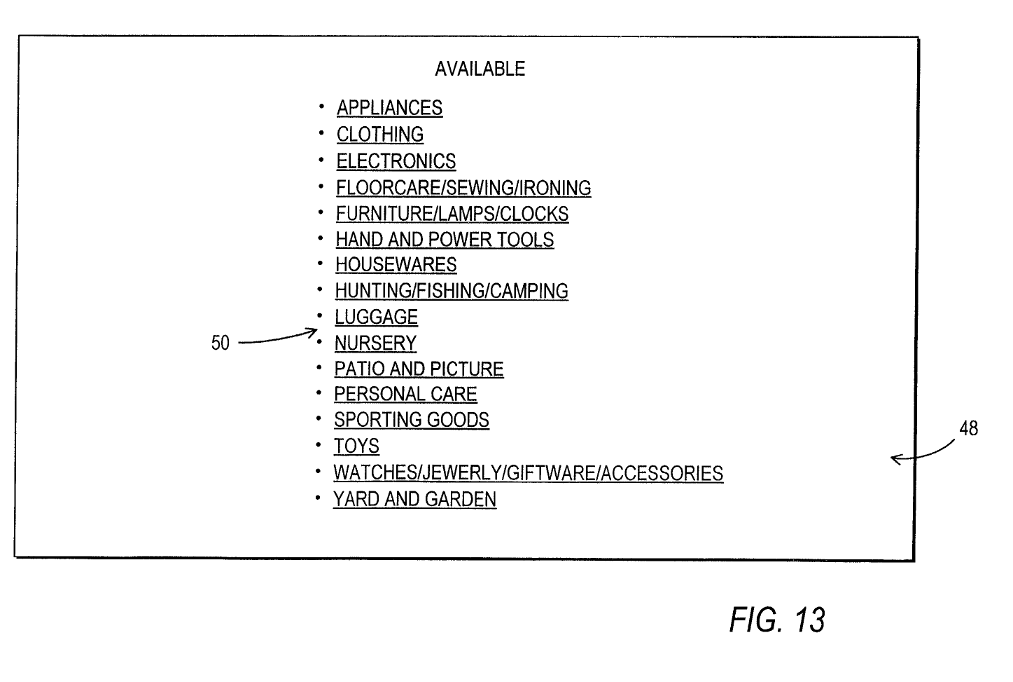

As an incentive for participating in the training program, part or all of the reward points earned by a participant may be used by that participant to redeem certain items by entering a redemption process as shown at step B in FIG. 12. If the participant wishes to redeem, in step 1000, the participant may access a web page 48 (FIG. 13) or, if the participant changes his or her mind and does not wish to redeem at this stage, the participant may return to the home page 30 (step A, FIG. 2) or end the session.

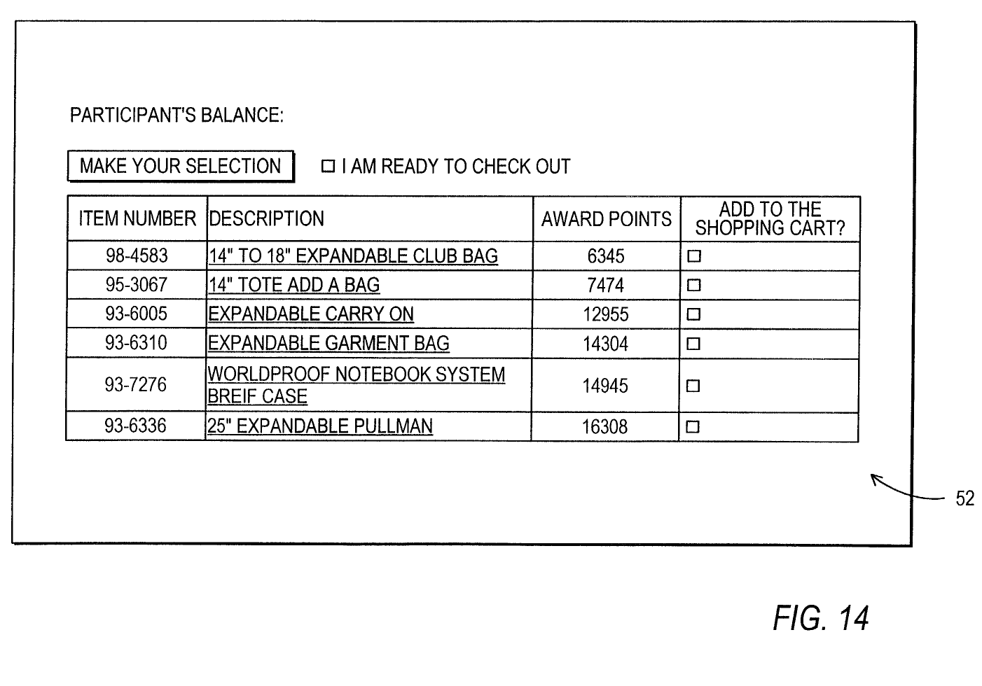

As shown in FIG. 13, a web page 48 containing a list of all of the categories of the available redeemable items according to this embodiment, which may be accessed by the participant. Each category shown on this list may include a hyper-link 50 to another web page on which a number of redeemable items are shown. For example, when Luggage A is selected, a web page 52 displaying all of the redeemable items in this category can be accessed as shown in FIG. 14. The web page 14 contains a table in which the redeemable items are listed. In the column labeled Description, a brief description of the item is provided. This brief description is hyper-linked to another page (not shown) in which a more detailed description of the item is provided.

The column labeled Award points in the table shown in FIG. 14, displays the reward points that are necessary for redeeming a listed item. For example, to redeem the first redeemable item in the list, 6345 points are necessary. Preferably, the participant's total reward points are displayed so that the participant can readily decide whether there are enough points to redeem a particular redeemable item or items. A participant may preliminarily select an item from the list by marking a corresponding check box provided in the column labeled Add to the shopping cart.

More than one item may be selected in this manner from the list. The participant may then place a check mark in the I am ready to check out box to the left of the line before leaving this web page. By pressing the button labeled “Make Your Selection”, the items that are marked are selected (step 1100, FIG. 12). It is then determined whether the participant has enough points in order to be able to redeem the selected items. If the participant has enough points a redemption of the selected item or items is completed. After the redemption, the participant's redemption points are reduced accordingly, and the reduced amount is stored in the database 35. Thereafter, the redeemed item or items are sent to the participant.

In addition to the test reward points, preferably, each participant may also receive sales reward points. These points are awarded based on the participant's sales performance, which may be based on the number and type of items that are sold by that participant in a given period of time. The sales reward points for the sales performance of each participant from each participating organization is loaded into the database every sales period. For example, sales reward points may be loaded into the database on a monthly basis. The sales reward points may be added to the total reward points and used for redemption of redeemable items in the same manner as described above. By combining sales reward points and the test reward points in one system, the redemption aspect of the incentive based training system may also be used to encourage sales performance by the participants.

After selecting an award, in step 1200 (FIG. 12), the participant may either return to the home page 30 or end the session.

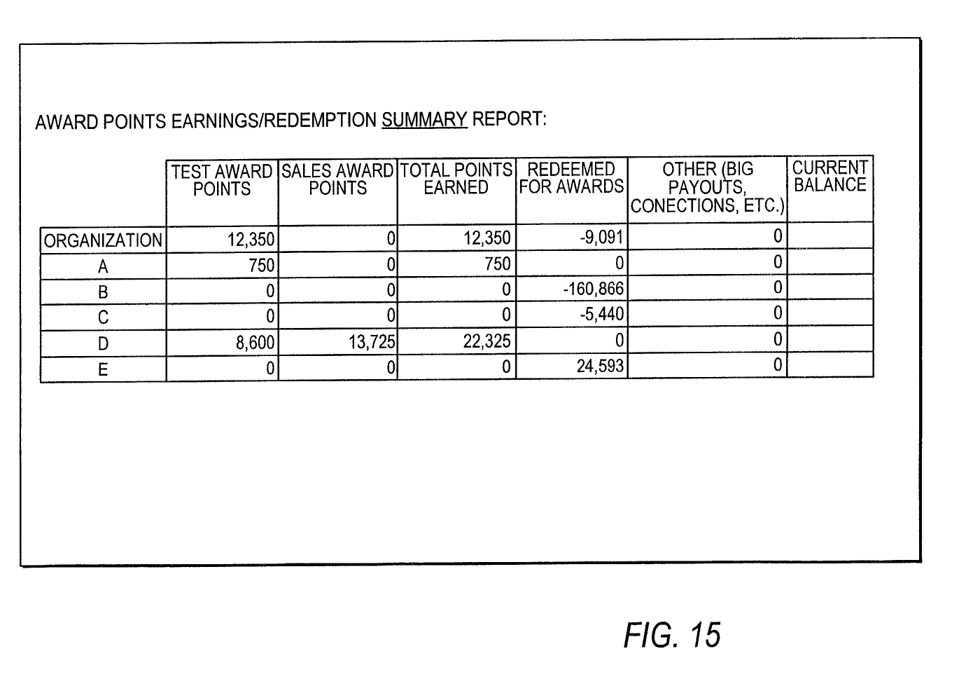

In order to assess the effectiveness of the incentive training program, the sales performance and the training progress of participants of each participating organization may be monitored using the data that is stored in the database. FIG. 15 shows an example of a report, presented in the form of a table in a web page, which may be used for such monitoring purposes. In this table, a list of participating organizations is provided in the first column from left. In the column labeled “Test Award Points” the total number of test reward points assigned to the participants in that organization is displayed. Similarly, in the column labeled “Sales Award Points”, the total number of sales reward points assigned to the participants in that organization is displayed. This table also includes a column, labeled “Total Points Earned”, for displaying the total number of points, which is the sum of the total number of test reward points, and the total number of sales reward points. Under the column labeled “Redeemed For Rewards” the total amount that has been redeemed by the participants at a listed participating organization is given. The column labeled “Other” includes points awarded for miscellaneous reasons such as corrections. In the column labeled “Current Balance”, the current unredeemed points for each listed organization is provided. The last row in the table provides the totals for each column in the table.

From this table, the administrator of the incentive based system can determine the level of sales and training activity at each participating organization. Also, the administrator can keep track of the costs associated with the program by viewing the total points redeemed, and the total number of points remaining to be redeemed. In this embodiment, the administrator may be, for example, a manufacturer that is interested in tracking the incentive based sales and training program of the instant invention for its distributors.

As an alternative to interacting with an award page to select an award, the participant may automatically receive an award when achieving a predetermined number of reward points. As a further alternative, a participant after being awarded a reward item, may have the option of trading-in the awarded item for a comparable item.

The advantages of the incentive based training method of the instant invention, over the conventional methods previously described are easy to discern from the foregoing detailed description. First, because the method is carried out over a network which can be accessed at any time of day, the drawbacks associated with the time and location of the training are eliminated. Moreover, because information about new products can be provided through the network at any time, the problems associated with arranging a training session each time a new product is introduced are also eliminated. In addition, the incentive aspects of the system encourage self-training, which reduces the costs associated with on-going training programs, as well as improving conventional self-training methods, such as providing literature to the salespersons.

In addition, the disclosed method generates data, which may be accessed to track the training progress of participating salespersons. This data may be useful in objective management decision making as previously explained by way of examples. This aspect of the invention, therefore, overcomes the problems associated with the lack of objectivity associated with the conventional methods of training, which prevent management from objectively gauging the effectiveness of training programs.

Also, based on results in the content of the training program, as well as associated test criteria may be changed, added or deleted.

A preferred embodiment for a method for implementing an incentive based training program has been disclosed. This preferred embodiment is realized in a system using the Internet as a network, and the World Wide Web as a preferred information service. The preferred embodiment disclosed herein is the best mode known to the inventors and is being provided as an example of an embodiment of the invention; it being understood, however, that many embodiments of the instant invention may be realized using other networks and information exchange services without departing from the spirit and scope of the invention. Therefore, the scope of the invention should be determined only by the claims appended hereto, and not the specific embodiments disclosed herein.

What is claimed is:

1. A method for administering an incentive based training program for a number of trainees via a communication network, said method comprising:
administering a test to one of said trainees via the communications network, said test including a number of questions;
awarding test reward points to said participant when a pre-determined percentage of the questions has been answered correctly; and
providing a redemption listing to said participant via the communications network, said redemption listing including at least one redeemable item having corresponding redemption points, whereby said participant can select said at least one redeemable item by submitting a request for its redemption via said communications network.

2. The method for administering the incentive based training program of claim 1, further comprising retrievably storing said test reward points in a database.

3. The method for administering the incentive based training program of claim 1, wherein a plurality of tests are administered to a plurality of trainees.

4. The method for administering the incentive based reward program of claim 1, further comprising retrievably storing sales reward points for each one of said trainees in said database.

5. The method for administering the incentive based training program of claim 1, further comprising approving said redemption request when said participant's test reward points are more than said redemption points.

6. The method for administering the incentive based training program of claim 5, further comprising disapproving said request for redemption when said test reward points are less than said required redemption points.

7. The method for administering the incentive based reward program of claim 5, further comprising retrievably storing sales reward points for each one of said trainees in said database.

8. The method for administering the incentive based training program of claim 7, wherein said approving is carried out when a sum of said sales reward points and said earned reward points is more than said redemption points.

9. The method for administering the incentive based training program of claim 8, further comprising disapproving of said request for redemption when said sum is less than said required redemption points.

10. The method for administering the incentive based training program of claim 1, wherein said redemption listing includes a description of said one redeemable item, and further comprising providing said description of said at least one redeemable item to said participant via said communications network in response to a request from said user computer.

11. The method for administering the incentive based training program of claim 1, further comprising re-administering said test when a pre-determined percentage of correct answers has not been received by said processing facility.

12. A method for administering an incentive based training program of claim 11, wherein said test is re-administered upon the request of the participant.

13. The method for administering the incentive based training program of claim 11, further comprising keeping count of each time said test has been administered until said predetermined percentage of correct answers has been received.

14. The method for administering the incentive based training program of claim 1, wherein the communications network is the Internet.

15. A method for administering an incentive based training program for a number of trainees on a communication network, said method comprising:
administering a test to one of said trainees via the communications network, said test including a number of questions;
awarding test reward points to said participant when a predetermined percentage of the questions has been answered correctly; and
providing an award to said participant when said participant receives a predetermined number of test reward points.

16. The method for administering the incentive based training program of claim 15, wherein said communications network is the Internet.

17. A method for receiving incentive based training comprising:
a) receiving a test from a test facility via a network, said test including a number of questions each having a corresponding correct answer;
b) taking the test;
c) forwarding answers to each of the test questions to the test facility via the communications network;
d) receiving notification via the communications network whether the test has been passed; and
e) if the test has been passed, receiving a predetermined number of reward points.

18. The method for receiving incentive based training of claim 17, wherein if the test has not been passed, steps a) to e) are repeated.

19. The method for receiving incentive based training of claim 18, wherein the repetition of steps a) to e) at least one of the questions in the test is different than a question asked in a previous test.

20. An incentive based training system for training a trainee, said system comprising:
a communication network, said network connected to a central processing facility to receive requests from a user terminal connected to said network;
a bank of retrievable training materials retrievably stored in a storage facility operatively connected to said central processing facility, wherein said central processing facility performs functions including:
retrieving at least a portion of said training materials from said storage facility;
providing said portion to said trainee via the communications network;
administering at least one test to said trainee via said communications network, said test including a plurality of questions related to said portion of said training materials, each question having a corresponding correct answer;
receiving an answer for each one of said questions from said trainee via said communications network;
assigning test reward points when a pre-determined percentage of correct answers have been received for said test; and
providing a prize list to said trainee via said communications network, said prize list containing at least one redeemable item and corresponding redemption points for said at least one redeemable item, wherein said trainee may redeem said at least one redeemable item when said test reward points are more than said redemption points.

21. The incentive based training system of claim 20, wherein said central processing facility keeps a count of a total number of times said at least one test has been administered.

22. The incentive based training system of claim 21, wherein said central processing facility retrievably stores said total number of times in a database.

23. The incentive based training system of claim 22, wherein said central processing facility re-administers said at least one test until a pre-determined percentage of correct answers has been received.

24. The incentive based training system of claim 23, wherein said processing facility retrievably stores a time, a date, and a corresponding percentage of correct answers that have been received by said processing facility for each time said test is administered in said database.

25. The incentive based training system of claim 24, wherein said processing facility provides to said trainee via said communications network, said time, said date and said percentage of correct answers for each time said test is administered.

26. The incentive based training system of claim 20, wherein said processing facility performs its functions for a plurality of trainees.

27. The incentive based training system of claim 20 , wherein the communications network is the Internet.
